(19) United States
(12) Patent Application Publication
(10) Pub. No.: US 2005/0240476 A1
(43) Pub. Date: Oct. 27, 2005

(54) Online electronic game based- e-commerce and data mining system

(76) Inventor: Frank Bigott, Santa Monica, CA (US)

Correspondence Address: Frank Bigott, Suite 1550, 1233 Wilshire Blvd., Santa Monica, CA, 90403, US

(21) Appl. No.: 11/111,396

(22) Filed: Apr. 21, 2005

Related U.S. Application Data
(60) Provisional application No. 60/564,545, filed on Apr. 22, 2004.

(51) Int. Cl. G06F 17/60; A63F 9/24; A63F 13/00; G06F 17/00; G06F 19/00; H04K 1/00; H04L 9/00

(52) U.S. Cl. 705/14; 463/1; 463/25

(57) ABSTRACT

A discount selling platform in the form of an Internet web site is disclosed, wherein consumers play games to earn discounts on products purchased from the system, with the amount of the discount based on how well the games are played. Additionally the system is a consumer data mining web site, which collects personal information such as email address and demographic information from the users of the system before they are allowed to participate in said games.

### CROSS-REFERENCE TO RELATED APPLICATION

This application is based on Provisional Patent Application Serial No. 60/564,545 filed Apr. 22, 2004, entitled “WIN A DISCOUNT GAME-BASED ECOMMERCE SYSTEM”, by Bigott.

### BACKGROUND

The increasing growth and accessibility of the Internet has provided new opportunities to merchants to sell their goods and services online. As a result, there is fierce competition among merchants to attract and retain online shoppers. Online merchants are constantly looking for new ways to promote their goods and services in an effort to acquire new customers, and also to differentiate themselves from their competition in order to keep their customers coming back to them, maximizing their revenue.

One of the common methods of acquiring new customers is done through marketing efforts, such as advertising and promotions. These advertisements or promotions can be disseminated through different mediums such as the Internet, Email, Television, Newspapers, Magazines and others. The most valuable type of marketing is ‘targeted marketing’ which means that instead of marketing to the general public you can focus your marketing efforts to a specific audience of consumers that is already know to have an interest in goods or services similar to yours, increasing the probability that they will visit your website, respond to your e-mail, or otherwise make a purchase. It has been found that competition for obtaining consumer e-mail addresses for the purpose of effective target marketing, has emerged as a principal business objective.

Customer retention is an extremely important aspect of any business. Once consumers have visited your web site, made a purchase, or otherwise interacted with your company, a positive experience is one way to ensure that they will do business with you again and again. Providing incentives such as discounts, prizes, customer loyalty programs, and fun or entertaining experience are effective ways of promoting a positive experience and retaining customers. Essentially, if the customer thinks they are ‘getting a deal’ or otherwise have a pleasurable experience doing business with you, they continue to do so, and possibly recommend your business to others.

An excellent way to attract and retain customers is to provide simple and fun web-based games freely on your company's web site. Businesses like Yahoo! And Pepsi, are adding familiar games like hearts and crossword puzzles to their web sites as a way to keep customers coming back. These simple quick games, played in a web browser are usually aimed at a general audience and not the ‘hard core’ gamer looking for a fully immerse 3D experience. Nevertheless these simple games are extremely popular with the ‘casual gamer’, which constitute a very large percentage of the population. The rise of casual gaming is fueled by the spread of inexpensive computers and the Internet into mainstream society. Using games to improve business is nothing new; newspapers have been including crossword and other puzzles for years as a way to increase reader loyalty by providing dependable daily amusement. People of all ages and backgrounds enjoy being challenged by games and puzzles.

An online business that integrates games and puzzles into their website, or otherwise incorporates them into the consumers experience, will appeal to the majority of consumers and have a distinct advantage over competitors that do not. Additionally the ability to gather information relating to the demographics and interests of specific consumers or Internet ‘surfers’ that visit a company's web site, as well as a way to contact them such as an e-mail address or mailing address is extremely valuable. Such information can be used in targeted marketing efforts by the business that gathered it, or can be sold to other businesses or advertisers.

### BRIEF DESCRIPTION OF THE DRAWINGS

FIG. 1 is a diagram representing an overview of the current embodiment of the present invention.

FIG. 2 represents a block diagram of the web server of the current embodiment of the present invention.

FIG. 3 represents the screen displayed in a web browser upon initial connection to the web server of the current embodiment of the present invention.

FIG. 4 represents screens displayed by the game module component of the current embodiment of the present invention.

### DETAILED DESCRIPTION OF THE EMBODIMENTS

In the following description of the invention, reference is made to the accompanying drawings, which form a part hereof, and in which is shown by way of illustration a specific example in which the invention may be practiced. It is to be understood that other embodiments may be utilized and structural changes may be made without departing from the scope of the present invention.

I. General Overview:

The embodiments of the present invention are operational in an online Internet web site environment, but can operate in any similar environment that facilitates interactivity for playing games, and provides a two-way connection between a consumer and a business or merchant (i.e. a set-top box operating over a cable television network).

The primary purpose of the present invention is to create an e-commerce selling system functioning to provide consumers with a plurality of products, which they can purchase at a discount based on how quickly they complete a time-based electronic game. Thus with the distinction of offering consumers a sliding scale discount determined by their how well they play a game, the system functions as a unique shopping system where consumers are challenged to earn a discount by way of a time investment in a game related to the product they desire to purchase.

The secondary function of the present invention is to create a system functioning to identify products which are the most significant to specific consumers, identify those consumers to advertisers or sellers of those products, and provide a connection between said consumer and advertisers or sellers via an e-mail address or mailing address. More specifically, the system is a ‘data mining’ Internet site that blends the challenge of earning a discount on a purchase by playing a game, winning free prizes, and an entertaining and effective advertising platform, which also functions to gather valuable consumer information. Thus, with the goal of discovering what particular products specific consumers are interested in at the present time, the system functions to generate the most qualified lead list for participating advertisers or sellers.

In order to participate in at least one game, players must provide personal information to the system, including but not limited to email address and demographic information about the player and various consumer preferences. The system may then compile a list of players for each game, functioning to create a valuable outline of consumers, their demographics, and their preferences, which may subsequently be sold or otherwise transferred to advertisers of particular products. Such should of course be considered highly qualified lead lists, generated by the system, for virtually any product or service to be promoted.

Moreover, one embodiment of the present invention may either require or request that the player grant the system permission to send them tailored marketing advertisements and related messages. In the preferred mode, such are sent via electronic mail for the purpose of convenience and expediency. However, the player may also grant the system permission to send said such “personal” advertisements via facsimile or ordinary mail. This allows advertisers to send targeted messages to players based upon selected products, demographic and psychographic criteria, contained on the system's database. Thus, for the purposes of example, the system functions to allow advertisers to tailor such messages to males between the ages of twenty-five and thirty-four years of age, to persons living in specific zip codes, or to persons who played a game for a specific product.

Furthermore, the system features the mechanism of advertisers providing products to be given away by the system as featured prizes in an hourly, daily, weekly or other time frame competition between visitors to the web site. Each visitor, after providing his or her contact and demographic information, would be allowed to play one game within the time frame for each prize. The visitor with the best score or lowest game time would win the prize. This would effectively increase the number of visitors to the web site; increase interest in that particular advertisers product, and gather additional valuable demographic and contact information from the visitors who play for the prizes.

II. Current Embodiment Overview:

In the current embodiment, the system of the present invention is a discount selling platform, in the form of an Internet web site, wherein consumers may play a game to earn a discount when they make a purchase from the system, and advertisers can identify the best prospective customers for any given product at any given time. This allows advertisers to deliver advertising messages specifically targeted to said customers for the utmost in advertising effectiveness.

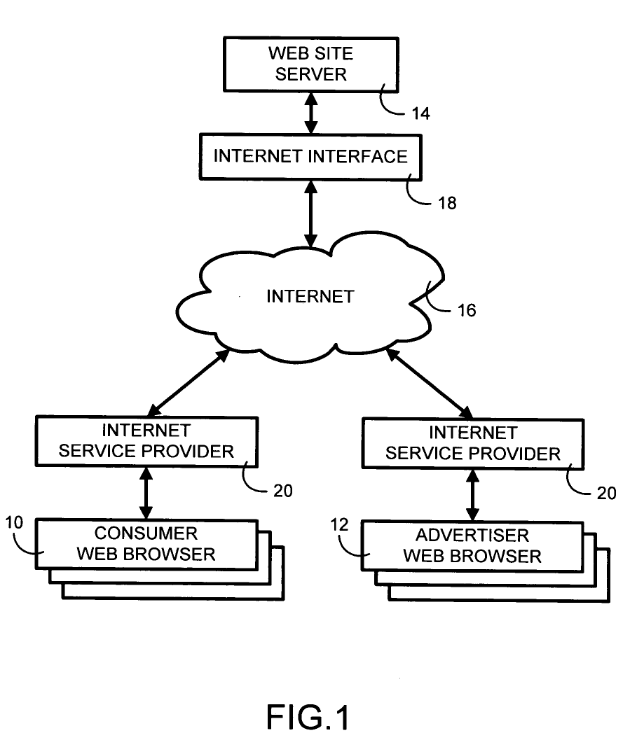

FIG. 1 is a diagram representing an overview of the current embodiment of the present invention. Show in FIG. 1 is a plurality of consumers operating Internet web-browsers 10, and a plurality of advertisers operating Internet web-browsers 12. A web-browser is an application that execute on a PC (personal computer), PDA (personal digital assistant), Cell Phone or other interactive electronic device that is used to access and interact with web servers on the Internet. The web-browsers 10 12 are connected to the Internet 16 by way of an Internet Service Provider 20. Typically this connection is made over a dial-up phone lines, DSL or Cable. The plurality of users operating web-browsers 10 12 can access and interact with the Internet addressable web-server 14 by entering the URL (universal resource locater) address for the web site that is hosted by the web-sever 14 into their web-browser. Additionally, access to the web-server 14 can be achieved independently and simultaneously by the user-operated web-browsers 10 12, which can be located anywhere in the world.

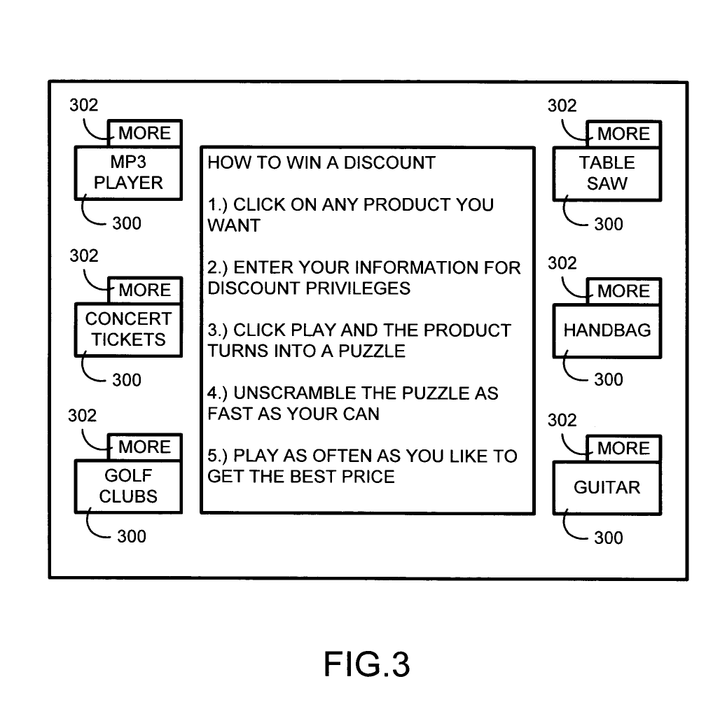

FIG. 3 represents the web page that is displayed when a consumer operating a web-browser initially connects to the web-server 14. As shown in FIG. 3, the consumer is presented with a plurality of products 300, which represent a featured selection of the products currently available by the participating advertisers. In addition to viewing the featured products, the consumer may click on one of the ‘more’ buttons 302 next to each of the featured products which will present them with a new group of products in a similar category to that particular featured product. This allows the consumer to search for and locate products matching their current interests or needs.

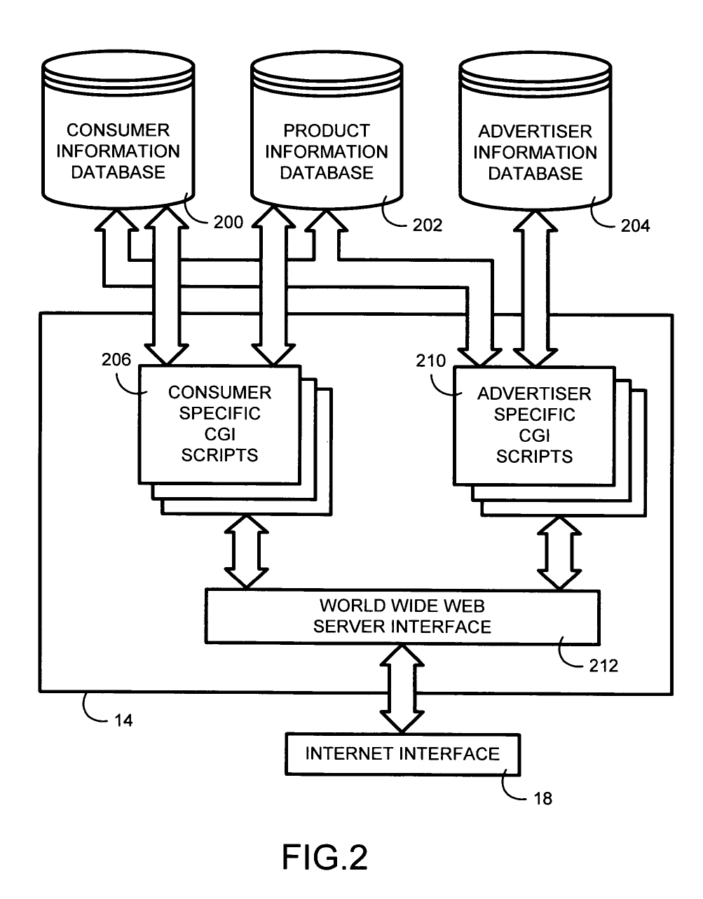

The currently featured products, as well as which products are available, will change over time based on which advertisers are participating or other factors such as trends in the marketplace. Each time a consumer connects to the web site, the web server will build and send to the consumer web pages that reflect the products that are currently available. Referring to FIG. 2, which represents a block diagram of the web server, a consumer will initiate a connection to the web server 14, requesting an initial the web page. The request is first received by the Internet interface 18 and passed to the World Wide Web (WWW) server module 212. Upon receiving this request, the WWW server module 212 will evaluate the request and recognize it as an initial connection request from a consumer. At this point a call to the ‘initial connection’ CGI (Common Gateway Interface) script 206 is made by WWW server module 212. The CGI script begins the process of building the web page. Since this is an initial connection by the consumer, a web page similar to that in FIG. 3 will be created. The CGI script queries information from the product information database 202. This database contains information on all the products that are currently available, such as its regular price, the maximum possible discount, quantity available, manufacturer, technical details, or other information. This database also contains information on which are the featured items. The CGI script builds the web page to reflect the information contained in the database, and returns its created web page back to the WWW server module 212, which sends the page via the Internet interface 18 over the Internet back to the consumer for display in their web browser 10.

The consumer will see displayed in their web browser 10, a screen that is similar to that in FIG. 3. If the consumer is not interested in purchasing any of the featured items shown, they may click on one of the ‘more’ buttons 302. The web page is created in such a way that upon clicking one of the ‘more’ buttons 302, a request is initiated to the web server 14 requesting a new web page containing products in the same category as the product associated with that particular ‘more’ button. The request is forwarded via the same mechanism described above back to the web server 14, and to WWW server module 212. Upon receiving this consumer's request for a web page containing more products relating to one particular category, the WWW server module 212 will call to the ‘product category clicked’ CGI script 206 to handle this request. The CGI script will then query the product information database 202 for all of the available products that are within that particular category. A web page is built by the CGI script, which represents the information from the database, and is returned to the WWW server module 202. This new web page is sent to the consumer's web browser 10, via the same mechanism described above, and viewed by the consumer.

All of the web pages containing products are crafted in such a way that If a consumer finds a product they are interested in, and they click on it, a request is generated and sent to the web server 14 which initiates the process of playing a game to receiving a sliding-scale discount on the product based on how well the game is played. Upon clicking on one of the product buttons 300, a request is sent by the consumer's web browser 10 to the web server 14, and received by WWW server module 212. Upon receiving this request the WWW server module 212 will call to the ‘product clicked’ CGI script 206 passing it the information on which product has been chosen. The ‘product clicked’ script builds a web page specifically for the specific product chosen by the consumer. This is the web page containing the ‘game module’ in which the consumer will play to try and maximize their discount. In this embodiment of the current invention, an image of the product is used in the game module, s well as its original selling price and its maximum discount, so to ‘product clicked’ CGI script will retrieve this information from product information database 202 and use it to generate the game module for this particular product.

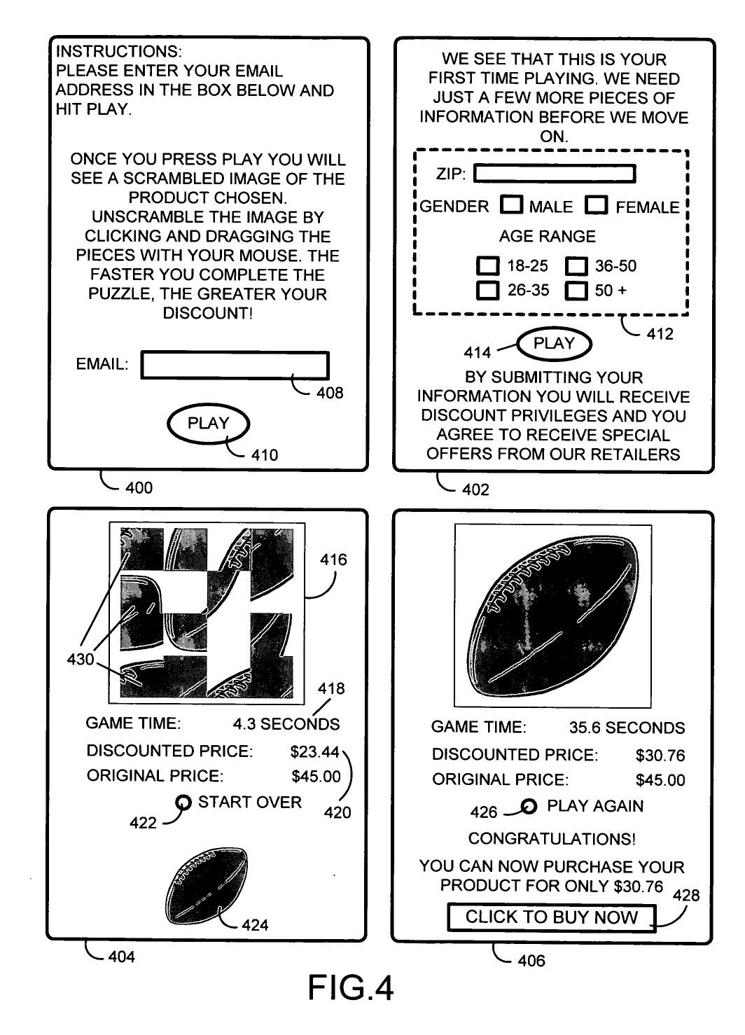

FIG. 4 contains representations of the ‘game module’ portion of the web page. It should be noted that in this embodiment the game module is implemented as a Macromedia® Flash web page component. Other mechanisms of implementing the game module could be used such as Java, JavaScript, ActiveX or any other mechanism that allows for interactivity as well as the ability to communicate back to the web server 14. Referring now to FIG. 4, screen 400 is presented to the consumer before playing the game. At this point the consumer must enter a valid email address 408 and click the ‘Play’ button 419 in order to continue.

When the consumer click on the play button 419, the game module validates the email address for correct syntax, if it is not valid a message appears indicating the email address is invalid and must be reentered. Once validated, the game module submits the email address to the web server 14. The web server queries the consumer information database 200 to see if this particular email address has been previously submitted to the system. If not, a new record is created in the database for this email address and the web server responds back to the game module that this is a new user.

Upon learning that this is a new user the game module will then display screen 402. The consumer must enter the required information into form 412, and press the play button 414 in order to continue. When the consumer clicks the play button 414 the information is validated for correctness and completeness. If the information entered is invalid or missing, a message appears indicating this to the consumer until it is corrected. Once the form is filled with valid data and the user clicks the play button, the e-mail address along with the demographic information entered by the consumer is forwarded to the web server 14, which stores the information in the consumer information database 200. This information is considered to be extremely valuable for use in ‘targeted advertising’ by the advertisers and merchants associated with the web site and can be made available to them or others at a later time. Simultaneous to clicking the play button, the game play begins in the consumer's web browser 10.

Referring to FIG. 4, the game play begins with a screen similar to 404. A pre-scrambled image of the product 416 appears. There is an increasing timer value 418 displayed indicating the amount of time that has passed while the game is being played. There is also an increasing discounted price 420 displayed, which indicates the price that the product would cost if the puzzle were completed at that particular moment. There is an image 424 of the completed puzzle shown as a guide. The consumer can click and drag any of the puzzle pieces 430 and reposition them elsewhere in the puzzle as they attempt to unscramble the image. At any point during the game play the consumer can click on the ‘Start Over’ button 422, which restarts and re-scrambles the puzzle without incurring any penalty. If and when the puzzle s correctly un-scrambled, timer 418 and discounted price 420 are frozen and the product is offered to the consumer at the discounted price.

Referring again to FIG. 4, when the consumer completes a puzzle they will see a screen similar to 406. The discounted price is shown and if the consumer is not satisfied with the price and would like another try at the puzzle they can click on the ‘Play Again’ button 426 to replay the game to try to get a better discount. If the consumer is satisfied with the discounted price and wishes to purchase the item they can click on the ‘CLICK TO BUY NOW’ button 428 which will bring then to the checkout portion of the web site to complete their purchase of that item.

In addition to consumers visiting the web site and playing games, advertisers operating a web browser 12 can access a special area of the web site that consumers cannot. Each advertiser is assigned a unique username and password, which allows them to access this special area. After logging into this advertisers area they have the ability to view in real time the information stored in the consumer information database 200 such as every player that registers to enter the game portion of the site, the players demographic information, which products they played for, how many times they played for that product and how long took them to complete each puzzle.

The foregoing has described the principles, embodiments and modes of operation of the present invention. However, the invention should not be construed as being limited to the particular embodiments discussed. The above-described embodiments should be regarded as illustrative rather than restrictive, and it should be appreciated that variations may be made in those embodiments by workers skilled in the art without departing from the scope of the present invention as defined by the following claims.

1. An ecommerce promotional tool, comprising:
a discount selling platform for selling products or services in the form of an Internet web site; and
online web-based Internet games coupled to the discount selling platform;
wherein users play the games to earn discounts on the products or services purchased from the platform and wherein the discounts are directly related to scoring of the games played.

2. The ecommerce promotional tool of claim 1, further comprising a database that collects personal information of the users.

3. The ecommerce promotional tool of claim 2, wherein an email address of each user of the games is collected.

4. The ecommerce promotional tool of claim 2, wherein demographic information of the users of the games is collected.

5. The ecommerce promotional tool of claim 1, wherein a purchase price of the products is directly related to a time it takes to complete a game.

6. The ecommerce promotional tool of claim 1, wherein at least one designated product or service is awarded for free to a user that completes a designated game with the highest score.

7. The ecommerce promotional tool of claim 1, wherein at least one designated product or service is awarded for free to a user that completes a designated game with the fastest time.

8. The ecommerce promotional tool of claim 1, wherein a portion of the games are time-based games.

9. The ecommerce promotional tool of claim 8, wherein a plurality of users compete asynchronously to achieve a fastest game completion time for the time-based games.

10. An ecommerce promotional method, comprising:
selling products or services on an Internet web site;
associating online web-based Internet games with the products or services;
allowing users that play the games to earn discounts on the products or services purchased from the ecommerce promotional tool; and
directly relating the discounts of the products or services to scores of the games played.

11. The ecommerce promotional method of claim 10, wherein a portion of the games are time-based games.

12. The ecommerce promotional method of claim 11, further comprising creating asynchronous competitions of a portion of the time-based games between plural users.

13. The ecommerce promotional method of claim 12, wherein a winner of the time-based games is determined as the user that has a fastest game completion time.

14. The ecommerce promotional method of claim 10, further comprising awarding a designated product or service for free to a user that completes a designated game with a fastest time.

15. The ecommerce promotional method of claim 10, wherein a purchase price of the products or services is directly related to a time it takes to complete a game.

16. In a web-based Internet environment with plural clients connected to a server for conducting ecommerce transactions, a method comprising:
offering products or services via the web-based Internet environment;
associating plural interactive web-based Internet games with the products or services;
directly associating discounts of designated products or services with scores of the games played;
allowing specified users to purchase the products or services at the discounts; and
providing a portion of the games as time-based games.

17. The method of 16, further comprising creating asynchronous competitions of a portion of the time-based games between plural users and wherein a winner of the time-based games is determined as the user that has a fastest game completion time.

18. The method of claim 16, further comprising awarding a designated product or service for free to a user that completes a designated game with a fastest time.

19. The method of claim 16, wherein a purchase price of the products or services is directly related to a time it takes to complete a game.

20. The method of claim 16, further comprising a database that collects personal information of the users.
